(19) United States
(12) Patent Application Publication
(10) Pub. No.: US 2011/0078476 A1
(43) Pub. Date: Mar. 31, 2011

(54) KEY INPUT APPARATUS USING A SWITCHING MATRIX

(76) Inventor: Sang Hyun Han, Gyeonggi-do (KR)

(21) Appl. No.: 12/991,739

(22) PCT Filed: May 12, 2009
(86) PCT No.: PCT/KR09/02489

§ 371 Date: Dec. 6, 2010

(30) Foreign Application Priority Data
May 13, 2008 (KR) 10-2008-0043778

(51) Int. Cl. G06F 1/32

(52) U.S. Cl. 713/320

(57) ABSTRACT

The present invention relates to a key input apparatus for a switching matrix. The present invention includes a column scan control device including switching units connected to the lines in the column scan direction in one-to-one correspondence in response to a column scan signal and an enable signal (EN) from the main controller, and performing a column scan operation for each of the modes according to a switching operation of the switching units of selectively receiving two input voltages (Vup and VA) for each column in normal scan mode and receiving a standby voltage (Vh) in power saving mode; and a row scan control device for performing a row scan in response to a row scan signal from the main controller in synchronization with a column scan signal from the column scan control device in normal scan mode, and operating in power saving mode in response to the enable signal (EN). Accordingly, the key input apparatus of the present invention controls a switch matrix using a switch having a simple construction, thereby providing the advantages of removing the ghost key phenomenon, operating in power saving mode and reducing manufacturing cost.

### TECHNICAL FIELD

The present invention relates to a key input apparatus for detecting switching operations in a switching matrix including a plurality of switches, as in a keyboard.

### BACKGROUND ART

In general, a keyboard in a computer system is one of the principal means for receiving input from the outside.

In many computer systems, the input of data to a central processing system is performed by manipulating keys on a keyboard.

A keyboard is generally provided with a keyboard interface, including a control structure for controlling information input using keys. A scan out line connected to an output port of a microcomputer and a scan in line connected to an input port of the microcomputer are connected to the keyboard interface.

A system interface transmits a status signal to the keyboard interface over the scan out line, and the scan out line and the scan in line form a connection in response to key input and the key input is determined.

Due to the above-described input method, a keyboard has a problem in that it is subjected to a phenomenon called a ghost key or a phantom key. The ghost key phenomenon refers to a phenomenon in which when three keys are simultaneously pressed on a keyboard, it is recognized that four keys have been pressed.

In the case of a person who conducts typing very fast, it is recognized that three keys have been simultaneously pressed even though the keys have been pressed individually, so that the ghost key phenomenon causes a key that has not been pressed by a user to be recognized as having been pressed.

In order to overcome this problem, a method of, when pressing of a third key is detected after pressing of a second key, considering the third key not to have been pressed is employed.

Furthermore, in the case where an operation is performed by pressing a Shift key, a Ctrl key and an Alt key simultaneously in combination, a method of disposing keys in a special arrangement and then preventing the ghost key phenomenon even when three keys are simultaneously pressed is employed.

However, although the above-described method is employed, there arises a problem in that an operation cannot be performed in the case where three or more normal keys, other than special keys, must be simultaneously pressed in combination in a program, such as in games currently being developed.

That is, in the case of a shooting game played on a personal computer (PC), pressing three normal keys, other than special keys such as a Ctrl key and an Alt key, in combination is required.

For example, when a ‘W’ key is set to upward movement, an ‘E’ key is set to left movement and the ‘P’ key is set to shooting and it is desired to shoot while moving in an upward left direction, three keys must be simultaneously pressed.

However, according to the conventional method of removing the ghost key phenomenon, the simultaneous operation of three keys may not be performed.

FIG. 1 is a schematic diagram showing a conventional key input apparatus for a switching matrix which is capable of removing the ghost key phenomenon.

In FIG. 1, a plurality of switching devices S1 . . . each including a resistor 6 and a switching element 5 connected in series is provided in a switching matrix 3 (in the present embodiment, 49 switching devices are constructed).

One end of each of the switching devices S1 . . . in the switching matrix 3 is connected to a relevant one of a first group of lines 1₀ to 1₆ (X lines). The other end of each of the switching devices S1 . . . is connected to a relevant one of a second group of lines 3₀ to 3₆ (Y lines).

The first ends of the first group of lines 1₀ to 1₆ are connected to a decoder 2.

The first ends of the second group of lines 3₀ to 3₆ are connected to a decoder 1, and the second ends thereof are connected to the selector 7 (a data selector having an analog switching system) of a detection circuit 4.

The decoder 1 functions to open one line selected from among the second group of lines 3₀ to 3₆ and apply a predetermined constant voltage to the remaining lines.

As described above, it is preferable to set the constant voltage of the decoder 1 to, for example, 3 V.

An excessive current preventing resistor r4, a diode Di for preventing reverse current and a Zener diode ZDi for providing constant voltage are located between the decoder 1 and one end of each of the second group of lines 3₀ to 3₆. Here, in order to output the voltage from the decoder 1 and the comparative voltage from the comparator, a number of expensive diodes must be used as shown in FIG. 1. In particular, it can be seen that the number of diodes connected to the decoder 1 must be equal to that of the switches.

The other end of each of the second group of lines 3₀ to 3₆ is connected to a selector 7. The selector 7 successively selects one from among the second group of lines, and connects it to a comparator 8, which is a voltage detection circuit for performing a switching operation.

The decoder 1 and the selector 7 perform a scan operation on the lines 3₀ to 3₆ in synchronization with a clock pulse signal. Accordingly, a line selected from among the second group of lines 3₀ to 3₆ by the decoder 1, for example, a line 3₀, is simultaneously selected by the selector 7, and is connected to the comparator 8.

Meanwhile, an appropriate voltage originating from a supply voltage Vcc, for example, 5 V, is applied to the input terminal N1 of the comparator 8 via an impedance R. Furthermore, the voltage of a line selected from among the second group of lines by the selector 7 is also applied to the terminal N1.

A resistor r3 and a Zener diode ZDi for limiting a detection reference voltage, for example, 2.5 to 3.0 V, are connected to the other input terminal N2.

In the present embodiment, the reference voltage is set to 2.6 V.

One end of each of the first group of lines 1₀ to 1₆ is connected to the decoder 2. The decoder 2 performs a scan operation in synchronization with the above-described scan operation of the selector 7 and the decoder 1. Furthermore, the decoder 2 functions to set the voltage of a line selected from among the first group of lines 1₀ to 1₆ to O V and set the remaining lines in an open state.

A line 3₀ is selected from among the second group of lines by the selector 7 and the decoder 1. Furthermore, when a line 1₀ is selected from among the first group of lines by the decoder 2, the voltage of the line 3₀ of the second group of lines is maintained at 5 V and the remaining lines of the second group of lines 3₁ to 3₆ are maintained at 3 V.

Meanwhile, when the line 1₀ of the first group is selected by the decoder 2, the voltage of the line 1₀ is set to O V and the remaining lines of the lines 1₀ to 1₆ are opened.

When in this situation, a switch S\textcircled{1} is pressed, the line 3₀ and the line 1₀ are connected to each other. Here, the voltage of the line 3₀ maintained at Vcc of 5V drops to O V, and a voltage of about O V is applied to the input terminal N1 of the comparator 8.

Strictly speaking, the voltage of the input terminal N2 does not completely drop to O V. The reason for this is that the resistor component r of the resistor 6 and the internal resistor component of the line 3₀ exist in a switching device S. However, when the resistor component r of the resistor 6 is set to a value lower than that of the impedance R, for example, 1/10 of the impedance R, a voltage input to the input terminal N1 may be considered to be O V.

This is based on the fact that the value of the impedance R and the resistor component r of the resistor 6 may vary independently of the present invention as will be described later.

Accordingly, in an input detection apparatus having such a construction, detection can be performed using only a single switch. For example, when only the switch S\textcircled{1} is pressed, the detection voltage of the line of the second group to which the switching device is connected is O V, so that the above fact can be detected. The reason for this is that a detection voltage of O V is lower than a detection reference voltage of 2.6 V.

Meanwhile, when the switch S\textcircled{1} is not pressed and other switching devices S\textcircled{2} to S\textcircled{4} are erroneously pressed simultaneously, a voltage input to the input terminal N1 of the comparator 8 is equal to or higher than 3 V.

Accordingly, the occurrence of leakage and passing of signal current can be detected.

Accordingly, it is possible to prevent an error in which the occurrence of leakage and passing signal voltage resulting from erroneous pressing of the switching devices S\textcircled{2} to S\textcircled{4} instead of the switching device S\textcircled{1} is considered to be pressing of the switching device S\textcircled{1}.

However, when a desired switching device and a plurality of other switching devices are simultaneously pressed, leakage and passing signal voltage is generated via a line of the second group to which the other switching devices are connected, so that detection voltage is increased.

Accordingly, a problem arises in that the operation of the desired switching device cannot be detected.

The leakage and passing signal voltage in the above-described situation will be described below.

In FIG. 1, when the switching devices S\textcircled{2} to S\textcircled{8} are erroneously pressed together with the desired switching device S\textcircled{1} simultaneously, the leakage and passing signal voltage V₈ expressed by the following Equation is detected as about 1.9 V.

$${V}_{8} = 3 V \times \frac{r}{2 / 3 \cdot r + r}$$

This voltage is much lower than a detection reference voltage of 2.6 V to be determined.

Accordingly, the operation of pressing the switch S\textcircled{1} can be accurately detected.

When the desired switching device S\textcircled{1} and nine other switching devices S (for example, the switching device S\textcircled{1} and the switching devices S\textcircled{3} to S\textcircled{11}, are simultaneously pressed, a total of 10 switches are redundantly closed, so that the leakage and passing signal voltage V₁₀ expressed by the following Equation is detected as about 2.05 V.

$${V}_{10} = 3 \times \frac{r}{6 / 13 \cdot r + r}$$

This voltage is much lower than a reference voltage of 2.6 V to be determined. Accordingly, an operation of pressing the switch S\textcircled{1} can be accurately detected.

However, this conventional method of removing the ghost key phenomenon has problems in that since a decoder and a selector are separately constructed in the configuration of a switch matrix, the manufacturing cost of a problem is increased due to the increase in the area of the system and there are difficulties with the design. Furthermore, there is a problem with commercialization because there is no definition of a power saving state.

Furthermore, since a number of normal diodes Di and constant voltage supplying Zener diodes ZDi equal to the number of lines 3₀ to 3₆ of the second group must be used in a switch arrangement, there is the problem of high manufacturing cost and there is difficulty with manufacturing.

### DISCLOSURE

### Technical Problem

Accordingly, the present invention has been made keeping in mind the above problems occurring in the prior art, and an object of the present invention is to provide a switching matrix-type key input apparatus which proposes the simple construction of a key input apparatus system easily applicable to mass production, so that it can be easily constructed within a single semiconductor in a single chip fashion, and which is capable of power saving.

### Technical Solution

In order to accomplish the above object, the present invention provides a key input apparatus for a switching matrix, the switching matrix including a plurality of switches in which lines in a column scan direction and lines in a row scan direction are connected under control of a main controller, the key input apparatus including a column scan control device including switching units connected to the lines in the column scan direction in one-to-one correspondence in response to a column scan signal and an enable signal (EN) from the main controller, and performing a column scan operation for each of the modes according to a switching operation of the switching units of selectively receiving two input voltages (Vup and VA) for each column in normal scan mode and receiving a standby voltage (Vh) in power saving mode; and a row scan control device for performing a row scan in response to a row scan signal from the main controller in synchronization with a column scan signal from the column scan control device in normal scan mode, and operating in power saving mode in response to the enable signal (EN).

Furthermore, the column scan control device may include a control unit for outputting a column scan signal and the enable signal (EN) under the control of the main controller; a plurality of switch units connected to the column scan lines in one-to-one correspondence so that a column scan can be performed by switching a column scan line selected by the column scan signal of the control unit and remaining column scan lines in response to input; a power supply unit configured to be selectively enabled and disabled in response to the enable signal of the control unit and to selectively output the input voltage (Vup), the supply voltage (VA) and the standby voltage (Vh) to the switch unit depending on normal scan mode and power saving mode; and a voltage comparator configured to be enabled in response to the enable signal from the control unit and then operate in normal scan mode and to be disabled in response to an enable signal from the control unit and then operate in power saving mode, wherein a reference voltage (VCCB) is generated based on resistance values of resistors (R1 and R2) for generating a reference voltage.

Furthermore, the power supply unit may be a constant voltage regulator.

Furthermore, the power supply unit may be a resistance division-type current amplifier.

Furthermore, the power supply unit may selectively supply the input voltage (Vup) and the supply voltage (VA) to each of the column scan lines of the switching matrix when the enable signal (EN) is enabled under the control of the main controller in normal scan mode.

Furthermore, the power supply unit may simultaneously connect the standby voltage (Vh) to all of the column scan lines of the switching matrix when the enable signal (EN) is disabled under the control of the main controller in power saving mode.

Furthermore, the column scan control device may apply the interrupt signal (INT) to the main controller when key input is performed by a user after in power saving mode, the standby voltage (Vh) supplied by the power supply unit has been connected and a row scan control device has connected all of the row scan control signal lines to 0 V.

Furthermore, with regard to the interrupt signal, the interrupt signal may not be generated in normal scan mode, and may be generated in power saving mode only when the key input is performed by the user.

Furthermore, the row scan control device may include a control unit for performing a function of sequentially connecting the row scan signal lines to 0 V under the control of the main controller in normal scan mode, and a function of connecting all of the row scan signal lines to 0 V in power saving mode.

Furthermore, the control unit may perform control so that the enable signal (EN) is disabled, with the result that the power supply unit and the voltage comparator are disabled, thereby minimizing power consumption in power saving mode.

### ADVANTAGEOUS EFFECTS

Accordingly, the key input apparatus of the present invention controls a switch matrix using a switch having a simple construction, thereby providing the advantages of removing the ghost key phenomenon, operating in power saving mode and reducing manufacturing cost.

### DESCRIPTION OF DRAWINGS

FIG. 1 is a schematic diagram showing a conventional key input apparatus for a switching matrix which is capable of removing the ghost key phenomenon;

FIG. 2 is a schematic diagram showing a key input apparatus for a switching matrix according to an embodiment of the present invention;

FIG. 3 is a detailed block diagram showing the column scan control device of the apparatus of FIG. 2;

FIG. 4 is a detailed block diagram showing the row scan control device of the apparatus of FIG. 2;

FIG. 5 is a reference diagram illustrating the operating state of the power supply unit of FIG. 3;

FIG. 6 is a detailed block diagram showing an embodiment of the power supply unit of FIG. 3; and

FIG. 7 is a detailed block diagram showing another embodiment of the power supply unit of FIG. 3.

### DESCRIPTION OF REFERENCE NUMERALS OF PRINCIPAL ELEMENTS IN THE DRAWINGS

11: column scan control device 12: switching matrix
13: row scan control device 121: switching element
122: switching resistor

### MODE FOR INVENTION

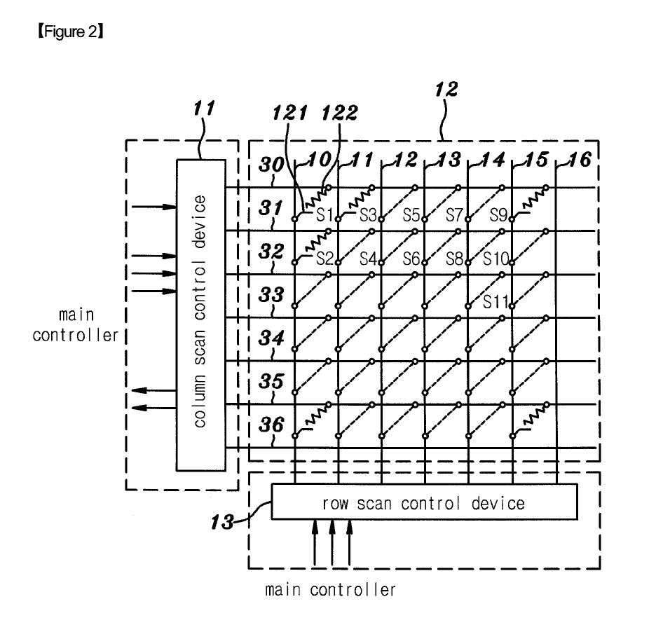

Preferred embodiments of the present invention will be described in detail below with reference to FIGS. 2 to 7.

FIG. 2 is a schematic diagram showing a key input apparatus for a switching matrix according to an embodiment of the present invention.

Referring to FIG. 2, the key input apparatus includes a switching matrix 12 composed of, for example, seven columns 3₀ to 3₆ and seven rows 1₀ to 1₆, a column scan control device 11 connected to the seven columns 3₀ to 3₆ and configured to control the column scan of key scanning, and a row scan control device 13 connected to seven rows 1₀ to 1₆ and configured to control the row scan of key scanning.

Furthermore, although not shown in this drawing, a main controller (a microcontroller unit is generally used as the main controller) for applying control signals to control the column scan control device 11 and the row scan control device 13 is provided.

The switching matrix 12 includes a plurality of switching devices S1, S2, S3, S4 . . . each including a switching element 121 and a switching resistor 122 connected in series (in the present embodiment, there are seven rows and seven columns, so that 49 switching devices are constructed).

One end of each of the switching devices S1, S2, S3 . . . is connected to each of the lines 1₀ to 1₆ in a row scan and the other end thereof is connected to each of the lines 3₀ to 3₆ in a column scan direction.

The first ends of the lines 1₀ to 1₆ in the row scan direction are connected to the row scan control device 13, and the second ends of the lines 3₀ to 3₆ in the column scan direction are connected to the column scan control device 11.

The column scan control device 11 functions to open one line selected from among the lines 3₀ to 3₆ in the column scan direction, and apply a predetermined constant voltage to the remaining lines.

It is preferable to set the above-described constant voltage to, for example, 3V.

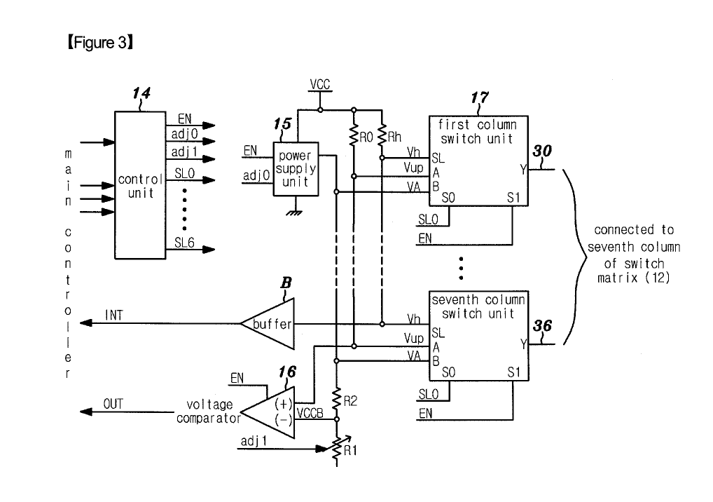

Furthermore, the column scan control device 11 configures a voltage comparator (reference numeral 16 of FIG. 3), that is, a voltage detection circuit for performing a switching operation, by successively selecting one from among the lines in the column scan direction.

The column scan control device 11 performs a scan operation on the lines 3₀ to 3₆ in the column scan direction under the control of the main controller. Here, one end of each of the lines 1₀ to 1₆ in the row scan direction is connected to the row scan control device 13 and performs a scan operation in synchronization with the scan operation of the column scan control device 11. Furthermore, the row scan control device 13 performs control so that the voltage of a selected one of the lines 1₀ to 1₆ in the row scan direction is set to O V and the remaining lines are opened.

The operation of the column scan control device 11 will be described in detail below with reference to FIG. 3.

FIG. 3 is a detailed block diagram showing the column scan control device of the apparatus of FIG. 2.

Referring to FIG. 3, the column scan control device 11 includes a control unit 14 configured to output a column scan signal and an enable signal EN under the control of the main controller, a power supply unit 15 configured to be enabled or disabled in response to an enable signal from the control unit 14, and a voltage comparator 16. Here, a first column switch unit 17 to a seventh column switch unit for performing a column scan by switching one column scan line selected by the column scan signal of the control unit 14 and the remaining six column scan lines are constructed. Although in FIG. 3, only the first column switch unit 17 is illustrated using a reference numeral, the seven switch units are respectively connected to the seven columns of the switch matrix 12, and are configured to be switched to the switch units of respective columns and then perform column scans sequentially. In FIG. 3, only the first column switch unit 17 and the seventh column switch unit are illustrated, and the illustration of the remaining second to sixth column switch units is omitted.

Furthermore, the column scan control device 11 includes a voltage comparator 16 connected to the respective switch units, and configured to compare a voltage Vup from a switch unit with a reference voltage VCCB and output the results of the comparison.

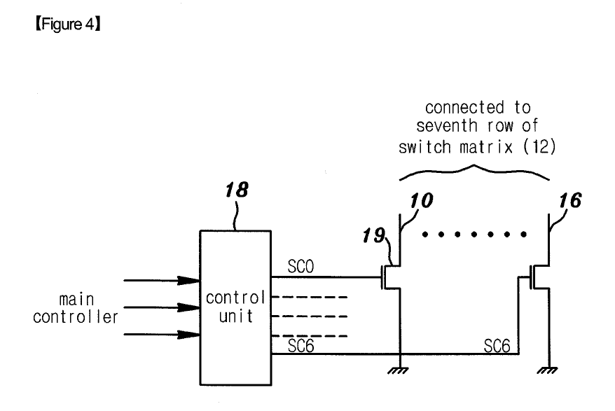

FIG. 4 is a detailed block diagram showing the row scan control device of the apparatus of FIG. 2.

Referring to FIG. 4, the row scan control device 13 includes a control unit 18 configured to perform control so that the switching matrix 12 performs a row scan in response to a row scan signal under the control of the main controller, and seven switches 19 . . . connected to seven rows to perform row scans in response to row scan signals SC0 to SC6 from the control unit 18. In FIG. 4, only the switch 19 of the first row and the switch of the last row switches are illustrated, and the illustration of the switches of the remaining rows is omitted.

The control unit 18 outputs a row scan signal under the control of the main controller, and performs a row scan in synchronization with the scan operation of a column scan by setting the ON resistance value of the switch 19 of a row selected in response to the row scan signal to 0 ohm and opening the switches of the remaining rows.

Here, the control unit 18 of the row scan control device 13 performs, in normal scan mode, a function of sequentially connecting row scan signal lines to 0 V under the control of the main controller and, in power saving mode, a function of connecting all of the row scan signal lines to 0 V.

The operation of the column scan control device 11 of FIG. 3 and the operation of the row scan control device 13 of FIG. 4 will be described in greater detail below.

In FIG. 3, the control unit 14 sequentially enables signal lines SL0 to SL6 in response to the column scan signals from the main controller so that column scan signals are applied to the first column switch unit 17 to the seventh column switch unit.

Then, when the enable signal EN is enabled, the first column switch unit 17 to the seventh column switch unit switches signals Vup and VA to a selected signal line and non-selected signal lines according to the values of the signal lines SL0 to SL6 so that they are connected to the lines 3₀ to 3₆ in the column scan direction. Here, the first column switch unit 17 to the seventh column switch unit are configured to selectively receive three input voltages from the power supply unit 15. The first column switch unit 17 to the seventh column switch unit perform switching so that they selectively receive the signals Vup and VA in a normal operating state in which the column scan signals SL0 to SL6 and the enable signal EN have been applied by the control unit 14 and receive a signal Vh in power saving mode. Here, the power supply unit 15 may vary an output voltage value depending on the adjustment value adj0 of the main controller.

The voltage comparator 16 determines whether a key input has been performed by the switch S1 by comparing the reference voltage VCCB with the input voltage Vup. That is, if key input has been performed by the switch S1, the input voltage Vup input to the voltage comparator 16 is lower than the reference voltage VCCB. In contrast, if key input has not been performed, the input voltage Vup has the same level as the supply voltage VCC. Here, the ratio between resistance values is determined such that an input voltage Vup lower than the reference voltage VCCB can be generated. That is, in order to determine the input voltage Vup input to the voltage comparator 16, the resistor R0 of FIG. 3 and the switching resistor 122 of FIG. 2 are adjusted, and in order to determine the reference voltage VCCB, the resistor R2 of FIG. 3 having a fixed value and the resistor R1 of FIG. 2 having a variable resistance value are adjusted.

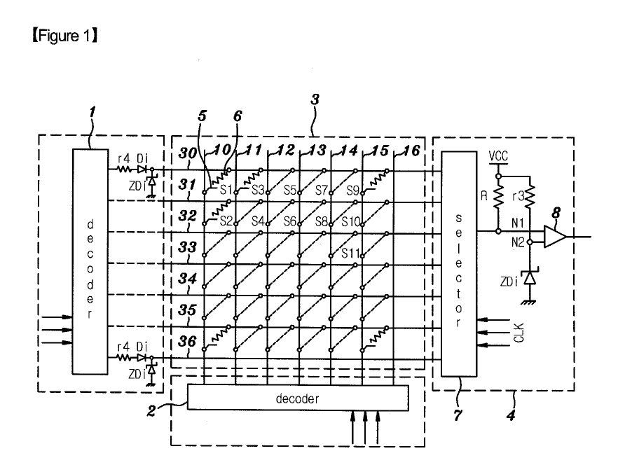

The comparator 8 of the existing system shown in FIG. 1 must use expensive high-power diodes and resistors for limiting the current of the diodes. However, in the present embodiment, implementation can be simply performed by adjusting the resistor R2 having a fixed value and the resistor R1 having a variable value in order to generate the reference voltage of the voltage comparator 16.

Here, the relationship between the resistors and the voltages will be described in greater detail below using the following equations.

In the case where the voltage of the supply voltage VCC is set to 5.0 V, R0 is set to 10K Ohm, the switching resistor 15 is set to 7K Ohm (in the following equation, it is denoted by r), VA is set to 3.0 V, the ON resistance value of the switch 19 of FIG. 4 is set to 0 Ohm actual (although this is not actually 0 Ohm, this can be disregarded because this is a vary low resistance value), when a row or column scan occurs and a relevant switch is pressed, the input voltage Vup1 is as follows:

Vup1=5.0 V×(r/R0+r)

Vup1=5.0 V×(7K/10K+7K)

Vup1=2.059 V

When the reference voltage VCCB of the voltage comparator is set to 2.5 V by adjusting the resistors R2 and R1 capable of adjusting the voltage VA of the power supply unit 15, it is recognized that a relevant key s1 has been pressed because the voltage Vup1 is lower than 2.5 V.

If no key has been pressed, the voltage Vup1 has a value close to that of the supply voltage VCC, so that it is higher than the reference voltage VCCB, with the result that it can be recognized that no key has been pressed.

As a result, the supply voltage VCC is the highest voltage, the supply voltage VA of the power supply unit 15 is an intermediate voltage, and the reference voltage VCCB is the lowest of the three voltages. The present invention is configured to satisfy the following Equation:

VCC>VA>VCCB (1)

Furthermore, the input voltage Vup occurring when one or more keys have been pressed always has the following relationship:

VCCB>Vup (2)

Furthermore, the input voltage Vup occurring when no key has been pressed has the following relationship:

VCCB<Vup, Vup=VCC (3)

Furthermore, in order to prevent a non-pressed key from being mistaken for a pressed key due to the ghost key phenomenon even when a number of keys that cause the ghost key phenomenon have been pressed according to the present invention, the configuration of the system that satisfies Equations 1 to 3 is required. Accordingly, even if a combination of about 10 keys that may cause the ghost key phenomenon are simultaneously pressed, a non-pressed key can be accurately determined.

Furthermore, in order to prevent the ghost key phenomenon in which the switch s1 is recognized as having been pressed in the case where the switches s2, s3 and s4 of FIG. 2 have been simultaneously pressed, a Vup signal voltage Vup3 generates a voltage of about 3.39 V higher than the reference voltage of 2.5 V of the voltage comparator, so that the switch s1 is not recognized as having been pressed.

Vup3=3×r×5/(R0+3×r)

Vup3=3×7K×5/(10K+3×7K)

Vup3=3.387 V

In the same way, in order to prevent the ghost key phenomenon in which the switch S1 is recognized as having been pressed even in the case where the six switches s2, s3, s4, s5, s6 and s7 of FIG. 2 have been simultaneously pressed, a Vup signal voltage Vup6 is a voltage of about 2.56 V higher than the reference voltage of 2.5 V of the voltage comparator, so that the switch s1 is not recognized as having been pressed.

Vup6=5×1.5×r/(R0+1.5×r)

Vup6=5×1.5×7K/(10K+1.5×7K)

Vup6=2.561 V

Accordingly, in the case where a key has been intentionally pressed, the input voltage Vup1 lower than the reference voltage VCCB is generated, so that the key is recognized as having been pressed. Although the ghost key phenomenon occurs because a number of adjacent keys equal to or larger than a predetermined number have been pressed, the input voltage Vup3 or Vup6 higher than the reference voltage VCCB is generated and is made not to reach a rollover voltage, so that a non-pressed key can be determined.

The reason why in this case, the resistor R2 having a fixed value and the variable resistor R1 are used to generate the reference voltage VCCB of the voltage comparator 16 is to implement a function of reasonably selecting a comparative voltage depending on the variation in the resistance value of a membrane switch that varies per manufacturer in the case of mass production.

In FIG. 3, when the enable signal EN is enabled under the control of the main controller, the power supply unit 15 supplies the voltage VA and Vup at a uniform level. In power saving mode, under the control of the main controller, the enable signal EN is disabled, and the power supply unit 15 and the voltage comparator 16 are set to a disabled state when row scan signals are all ON. That is, the power supply unit 15 is designed such that in power saving mode, when the enable signal EN from the control unit 14 is disabled, the bias of the power supply unit 15 is released and no current flows at all. In the same way, the voltage comparator 16 is designed such that in power saving mode, the enable signal EN from the control unit is disabled, the bias of the voltage comparator 16 is released and no current flows at all.

In this case, under the control of the main controller, in power saving mode, the first column switch unit 19 to the seventh column switch units apply standby voltage Vh to the lines 3₀ to 3₆ of the switch matrix 12 in the column scan direction regardless of control signals SL0 to SL6.

When the enable signal EN of the main controller is disabled, the scanning of column scan signals is stopped so as to minimize the current that is consumed by the circuit to operate in power saving mode. After the scanning of row scan signals has been also stopped, column scan signals are all connected to standby voltage Vh through the first to seventh column switch units and are provided with standby voltage Vh, and all of the switches 19 . . . are turned on and a voltage of 0 V is applied to the lines 1₀ to 1₆ in the row scan direction.

When the power saving mode has been entered, the interrupt of the main controller is enabled and the clock of the main controller is stopped, thus entering the maximum power saving state. Thereafter, when a user's key input occurs, the main controller is woke up in power saving mode by an interrupt signal and generates clocks in normal scan mode.

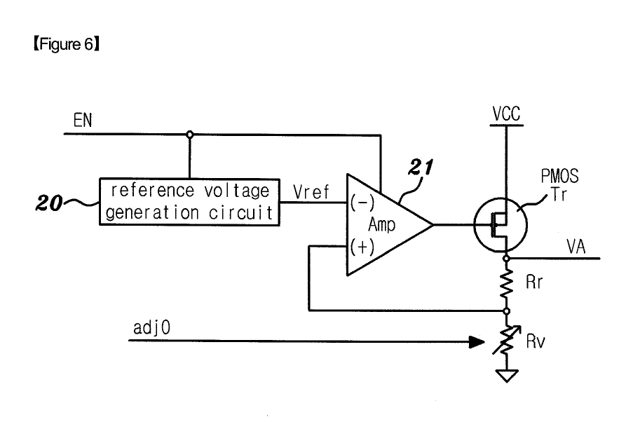

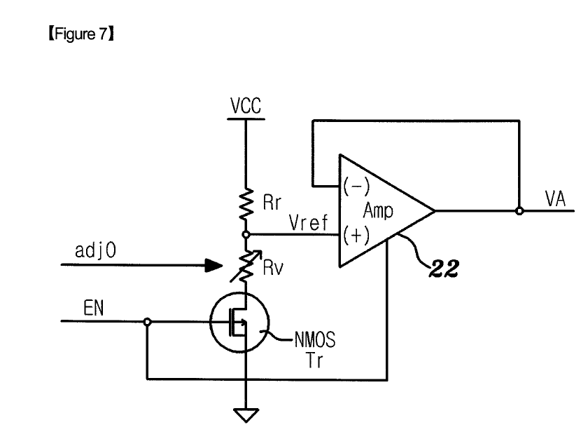

Although a power supply unit uses a plurality of expensive diodes Di, Zener diodes ZDi and resistors r4 for limiting the current of the Zener diodes for column scan signals so as to support the output voltage of the decoder of FIG. 1, the single power supply unit 15 having the structure disclosed in FIGS. 6 and 7 and using the supply voltage VCC is used to supply voltage VA to the first column switch unit 17.

That is, of the three types of voltages supplied to the switch unit 17, the two types of voltages Vup and VA in a normal operating state become voltage VA output from the power supply unit 15 and a voltage Vup generated based on a resistor R0 connected to the supply voltage VCC, and the standby voltage Vh in power saving mode becomes voltage generated based on a resistor Rh connected to the supply voltage VCC. Accordingly, the voltages Vup and Vh are voltages that are generated based on the impedance of the resistors R0 and Rh connected in series to the supply voltage VCC, and all become equal to the supply voltage VCC both in the case where the switch of the switching matrix 12 is not pressed and in the case where the connection from the first column switch unit 17 via a column scan line is not set up. However, in the case where a connection from the switch unit 17 is formed via a column scan line (here, the ON resistor of the switch unit 17 is not illustrated, and has a very small value, which is considered to be 0 ohm) and a switch in the switching matrix 12 is pressed, a series connection to the ground is formed through the switching resistor 122 of the switching matrix connected via the first column switch unit 17, the switching element 121, that is, the ON resistor of a switch, and the ON resistor of the switch 19 of the row scan control device, so that the voltage Vup or Vh based on the proportional resistance between the supply voltage VCC and the ground potential 0 V is generated.

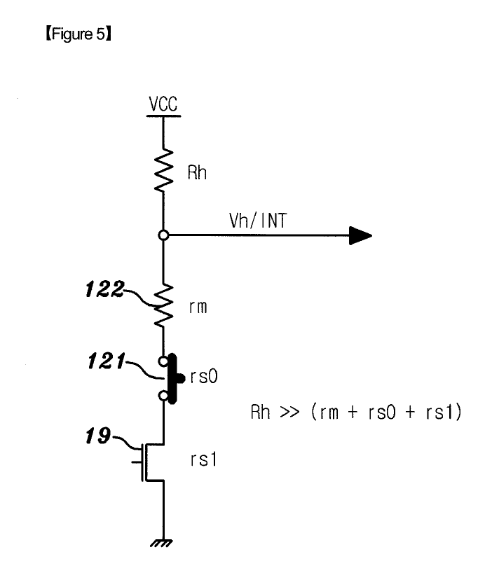

A power saving state in the operation of the power supply unit and the switch unit will be described in greater detail below with reference to FIG. 5.

FIG. 5 is a reference diagram illustrating a power saving state of the operation of FIG. 3.

Power saving mode is entered in the case where there has not been a user's key input using the switching matrix 12 for a predetermined period or a Universal Serial Bus (USB) keyboard enters suspend mode. When power saving mode is entered, the enable signal EN of the control unit 14 is disabled and, thus, the power supply unit 15 and the voltage comparator 16 are disabled, thus changing to the maximum power saving state. Furthermore, the first column switch unit 17 to the seventh column switch unit connect the supply voltage VCC and a resistor Rh having a large resistance value to all of the lines 3₀ to 3₆ in the column scan direction, and set supply voltage VCC-level voltage on all of the lines 3₀ to 3₆ in the column scan direction. Furthermore, the lines 1₀ to 1₆ in the row scan direction are set to 0 V by setting all of the switches 19 . . . of the row scan control device 13 to an ON state. By doing so, the maximum power saving state is entered in power saving mode, so that the main controller enables interrupt and stops the generation of clocks.

Referring to FIG. 5, the power saving mode will now be described from the viewpoint of a simple circuit configuration. This is the state where rs0 (the symbolized state of the physical switching elements 121 of the switching matrix 12 shown in FIG. 2) of the switch element 121 is opened, and the lines 3₀ to 3₆ in the column scan direction are all pulled up by the resistor Rh. Furthermore, all of the lines 1₀ to 1₆ in the row scan direction have about 0 V in the state where an N-channel open drain has been enabled by an NMOS TR 19. At this time, an interrupt signal INT has a value around the supply voltage VCC in the same way as the voltage of the column scan lines and, thus, has the logic level of the “H” signal.

Furthermore, in FIG. 5, when in a power saving state, key input is performed by a user, the switching element rs0 (or 121 of FIG. 2) enters a connected state. Here, the pull-up resistor Rh, the switching resistor rm (or 122 of FIG. 2) and the series resistors of the ON resistor rs1 of the line switch 19 in the row scan direction are located between the supply voltage VCC and 0 V. At this time, with regard to the value of the voltage Vh, in the case where the resistance value of the resistor Rh has a sufficiently large value compared to the switching resistor (122 of FIG. 2:rm) in the switching matrix 12 and the ON resistors rs0 and rs1 of the switches have sufficiently small values compared to the resistor Rh or rm, the voltage Vh has a value around 0 V and, thus, has the logic level of the “L” signal.

At this time, with regard to the interrupt signal INT, the voltage Vh has a value around 0 V, so that the interrupt signal INT is output to the main controller, thereby notifying the main controller of a wake-up state (a change to a normal state).

In response to this interrupt signal, the main controller generates clocks again, and controls the column scan control device 11 and the row scan control device 13 so that column scan control and row scan control can be performed.

In such a power saving state, the standby voltage Vh of FIG. 3 is changed from an “H” signal to an “L” signal by a user's key input, the interrupt signal INT output to the main controller is generated by the buffer B of FIG. 3. At this time, the main controller receives the interrupt signal INT from the buffer B, escapes from the power saving state and operates in a normal key input detection state, so that the location of a key pressed by a user is detected and, thus, the value of the pressed key can be recognized by performing column and row scans so as to detect key input.

The power supply unit 15 may be constructed using the constant voltage regulator method and a current amplifier method based on resistance division.

FIG. 6 is a detailed block diagram showing an embodiment of the power supply unit of FIG. 3.

FIG. 6 shows an example of a constant voltage regulator-type power supply unit 15. An amplifier 21 receives reference voltage Vref for voltage VA to be output from a reference voltage generation circuit 20. Here, the current flowing through both ends of a PMOS transistor is controlled by appropriately controlling the voltage Vgs between the gate and source of the PMOS transistor using the comparison between the voltage based on the series resistors Rr and Rv, connected between a PMOS transistor PMOS Tr for voltage output and the ground, and voltage Vref, thereby generating a desired supply voltage VA.

FIG. 7 is a detailed block diagram showing another embodiment of the power supply unit of FIG. 3.

FIG. 7 shows an example of a current amplifier-type current supply unit 15 based on resistance division. A supply voltage VA is generated by amplifying only the current supply capability of voltage Vref, which is acquired by dividing the supply voltage VCC by resistors Rr and Rv, at the same voltage through the negative feedback of the amplifier 22 having an amplification factor of 1, and is then output.

The power supply units 15 disclosed in FIGS. 6 and 7 have a function of, to perform an operation in power saving mode, receiving an enable signal EN and disabling an operation, thereby minimizing current consumption in a disabled state, and have also a function of varying the value of generated output voltage depending on the adjustment value adj0 input from the main controller.

1. A key input apparatus for a switching matrix, the switching matrix including a plurality of switches in which lines in a column scan direction and lines in a row scan direction are connected under control of a main controller, the key input apparatus comprising:
a column scan control device including switching units connected to the lines in the column scan direction in one-to-one correspondence in response to a column scan signal and an enable signal (EN) from the main controller, and performing a column scan operation for each of the modes according to a switching operation of the switching units of selectively receiving two input voltages (Vup and VA) for each column in normal scan mode and receiving a standby voltage (Vh) in power saving mode; and
a row scan control device for performing a row scan in response to a row scan signal from the main controller in synchronization with a column scan signal from the column scan control device in normal scan mode, and operating in power saving mode in response to the enable signal (EN).

2. The key input apparatus as set forth in claim 1, wherein the column scan control device comprises:
a control unit for outputting a column scan signal and the enable signal (EN) under the control of the main controller;
a plurality of switch units connected to the column scan lines in one-to-one correspondence so that a column scan can be performed by switching a column scan line selected by the column scan signal of the control unit and remaining column scan lines in response to input;
a power supply unit configured to be selectively enabled and disabled in response to the enable signal of the control unit and to selectively output the input voltage (Vup), the supply voltage (VA) and the standby voltage (Vh) to the switch unit depending on normal scan mode and power saving mode; and
a voltage comparator configured to be enabled in response to the enable signal from the control unit and then operate in normal scan mode and to be disabled in response to an enable signal from the control unit and then operate in power saving mode, wherein a reference voltage (VCCB) is generated based on resistance values of resistors (R1 and R2) for generating a reference voltage.

3. The key input apparatus as set forth in claim 2, wherein the power supply unit is a constant voltage regulator.

4. The key input apparatus as set forth in claim 2, wherein the power supply unit is a resistance division-type current amplifier.

5. The key input apparatus as set forth in claim 2, wherein the power supply unit selectively supplies the input voltage (Vup) and the supply voltage (VA) to each of the column scan lines of the switching matrix when the enable signal (EN) is enabled under the control of the main controller in normal scan mode.

6. The key input apparatus as set forth in claim 2, wherein the power supply unit simultaneously connects the standby voltage (Vh) to all of the column scan lines of the switching matrix when the enable signal (EN) is disabled under the control of the main controller in power saving mode.

7. The key input apparatus as set forth in claim 6, wherein the column scan control device applies the interrupt signal (INT) to the main controller when key input is performed by a user after in power saving mode, the standby voltage (Vh) supplied by the power supply unit has been connected and a row scan control device has connected all of the row scan control signal lines to 0 V.

8. The key input apparatus as set forth in claim 7, wherein with regard to the interrupt signal, the interrupt signal is not generated in normal scan mode, and is generated in power saving mode only when the key input is performed by the user.

9. The key input apparatus as set forth in claim 7, wherein the row scan control device comprises a control unit for performing a function of sequentially connecting the row scan signal lines to 0 V under the control of the main controller in normal scan mode, and a function of connecting all of the row scan signal lines to 0 V in power saving mode.

10. The key input apparatus as set forth in claim 2, wherein the control unit performs control so that the enable signal (EN) is disabled, with the result that the power supply unit and the voltage comparator are disabled, thereby minimizing power consumption in power saving mode.
